(19) United States
(12) Patent Application Publication
(10) Pub. No.: US 2023/0058943 A1
(43) Pub. Date: Feb. 23, 2023

(54) Apparatus, Method and Computer Program

(71) Applicant: Nokia Technologies Oy, Espoo (FI)

(72) Inventors: Jussi-Pekka KOSKINEN, Oulu (FI); Samuli TURTINEN, li (FI); Jarkko Tuomo KOSKELA, Oulu (FI); Jakob Lindbjerg BUTHLER, Aalborg (DK)

(21) Appl. No.: 17/784,208

(22) PCT Filed: Dec. 2, 2020
(86) PCT No.: PCT/EP2020/084275

§ 371 Date: Jun. 10, 2022

(30) Foreign Application Priority Data
Dec. 13, 2019 (GB) 1918366.4

(51) Int. Cl. H04W 76/27; H04W 4/20; H04W 76/30

(52) U.S. Cl. CPC H04W 76/27; H04W 4/20; H04W 76/30

(57) ABSTRACT

There is provided an apparatus, said apparatus including circuitry configured for receiving an indication, at a user equipment from a network, to operate in an inactive state, receiving a criteria related to the inactive state, and in response to the criteria being met, performing one or more actions.

### FIELD

The present application relates to a method, apparatus, system and computer program and in particular but not exclusively to RRC INACTIVE mode optimisation.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communication sessions may comprise, for example, communication of data for carrying communications such as voice, video, electronic mail (email), text message, multimedia and/or content data and so on. Non-limiting examples of services provided comprise two-way or multi-way calls, data communication or multimedia services and access to a data network system, such as the Internet.

In a wireless communication system at least a part of a communication session between at least two stations occurs over a wireless link. Examples of wireless systems comprise public land mobile networks (PLMN), satellite based communication systems and different wireless local networks, for example wireless local area networks (WLAN). Some wireless systems can be divided into cells, and are therefore often referred to as cellular systems.

A user can access the communication system by means of an appropriate communication device or terminal. A communication device of a user may be referred to as user equipment (UE) or user device. A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. One example of a communications system is UTRAN (3G radio). Other examples of communication systems are the long-term evolution (LTE) of the Universal Mobile Telecommunications System (UMTS) radio-access technology and so-called 5G or New Radio (NR) networks. NR is being standardized by the 3rd Generation Partnership Project (3GPP).

### SUMMARY

In a first aspect there is provided an apparatus comprising means for: receiving an indication, at a user equipment from a network, to operate in an inactive state; receiving a criteria related to the inactive state; and in response to the criteria being met, performing one or more actions.

The criteria may comprise at least one of expiry of a timer, a timer reaching a threshold value, a time the user equipment has been in the inactive state and a data transfer pattern.

The means may be for receiving an indication of the criteria with the indication to operate in an inactive state or in system information.

The criteria may be preconfigured.

The means may be for: determining information relating to the inactive state; and wherein means for performing one or more actions comprises means for providing the information to the network.

The information relating to the inactive state may comprise at least one of an indication of whether data transmission is expected, a time for which the user equipment has been in the inactive state, a time for which the user equipment has been in the inactive state without data transmission, an indication of whether the user equipment has been in the inactive state for a given amount of time, an indication that the timer has expired and a data transfer pattern.

The data transmission may be associated with at least one data radio bearer, at least one logical channel or at least one protocol data unit session.

The data transmission may be downlink or uplink user data.

The means for performing one or more actions may comprise means for operating in an idle state.

The criteria may comprise a message from the network.

The message may comprise a paging message or a connection establishment message.

In a second aspect, there is provided an apparatus comprising means for: transmitting an indication, from a network to a user equipment, to operate in an inactive state; and transmitting a criteria related to the inactive state, wherein the criteria is configured to cause the user equipment to perform one or more actions when the criteria is met.

The criteria may comprise at least one of expiry of a timer, a timer reaching a threshold value, a time the user equipment has been in the inactive state and a data transfer pattern.

The means may be for transmitting an indication of the criteria with the indication to operate in an inactive state or in system information.

The means may be for: receiving, at the network from the user equipment, information relating to the inactive state.

The information relating to the inactive state may comprise at least one of an indication of whether data transmission is expected, a time for which the user equipment has been in the inactive state, a time for which the user equipment has been in the inactive state without data transmission, an indication of whether the user equipment has been in the inactive state for a given amount of time, an indication that the timer has expired and a data transfer pattern.

The data transmission may be associated with at least one data radio bearer, at least one logical channel or at least one protocol data unit session.

The data transmission may be downlink or uplink user data.

The criteria may comprise a message from the network.

The message may comprise a paging message or a connection establishment message. In a third aspect, there is provided a method comprising: receiving an indication, at a user equipment from a network, to operate in an inactive state; receiving a criteria related to the inactive state; and in response to the criteria being met, performing one or more actions.

The criteria may comprise at least one of expiry of a timer, a timer reaching a threshold value, a time the user equipment has been in the inactive state and a data transfer pattern.

The method may comprise receiving an indication of the criteria with the indication to operate in an inactive state or in system information.

The criteria may be preconfigured.

The method may comprise: determining information relating to the inactive state; and wherein performing one or more actions comprises providing the information to the network.

The information relating to the inactive state may comprise at least one of an indication of whether data transmission is expected, a time for which the user equipment has been in the inactive state, a time for which the user equipment has been in the inactive state without data transmission, an indication of whether the user equipment has been in the inactive state for a given amount of time, an indication that the timer has expired and a data transfer pattern.

The data transmission may be associated with at least one data radio bearer, at least one logical channel or at least one protocol data unit session.

The data transmission may be downlink or uplink user data.

Performing one or more actions may comprise operating in an idle state.

The criteria may comprise a message from the network.

The message may comprise a paging message or a connection establishment message.

In a fourth aspect, there is provided a method comprising: transmitting an indication, from a network to a user equipment, to operate in an inactive state; and transmitting a criteria related to the inactive state, wherein the criteria is configured to cause the user equipment to perform one or more actions when the criteria is met.

The criteria may comprise at least one of expiry of a timer, a timer reaching a threshold value, a time the user equipment has been in the inactive state and a data transfer pattern.

The method may comprise transmitting an indication of the criteria with the indication to operate in an inactive state or in system information.

The method may comprise: receiving, at the network from the user equipment, information relating to the inactive state.

The information relating to the inactive state may comprise at least one of an indication of whether data transmission is expected, a time for which the user equipment has been in the inactive state, a time for which the user equipment has been in the inactive state without data transmission, an indication of whether the user equipment has been in the inactive state for a given amount of time, an indication that the timer has expired and a data transfer pattern.

The data transmission may be associated with at least one data radio bearer, at least one logical channel or at least one protocol data unit session.

The data transmission may be downlink or uplink user data.

The criteria may comprise a message from the network.

The message may comprise a paging message or a connection establishment message.

In a fifth aspect, there is provided an apparatus comprising: at least one processor and at least one memory including a computer program code, the at least one memory and computer program code configured to, with the at least one processor, cause the apparatus at least to: receive an indication, at a user equipment from a network, to operate in an inactive state; receive a criteria related to the inactive state; and in response to the criteria being met, perform one or more actions.

The criteria may comprise at least one of expiry of a timer, a timer reaching a threshold value, a time the user equipment has been in the inactive state and a data transfer pattern.

The apparatus may be caused to receive an indication of the criteria with the indication to operate in an inactive state or in system information.

The criteria may be preconfigured.

The apparatus may be caused to: determine information relating to the inactive state; and wherein the apparatus being caused to perform one or more actions comprises the apparatus being caused to provide the information to the network.

The information relating to the inactive state may comprise at least one of an indication of whether data transmission is expected, a time for which the user equipment has been in the inactive state, a time for which the user equipment has been in the inactive state without data transmission, an indication of whether the user equipment has been in the inactive state for a given amount of time, an indication that the timer has expired and a data transfer pattern.

The data transmission may be associated with at least one data radio bearer, at least one logical channel or at least one protocol data unit session.

The data transmission may be downlink or uplink user data.

The apparatus being caused to perform one or more actions may comprise the apparatus being caused to operate in an idle state.

The criteria may comprise a message from the network.

The message may comprise a paging message or a connection establishment message.

In a sixth aspect, there is provided an apparatus comprising: at least one processor and at least one memory including a computer program code, the at least one memory and computer program code configured to, with the at least one processor, cause the apparatus at least to: transmit an indication, from a network to a user equipment, to operate in an inactive state; and transmit a criteria related to the inactive state, wherein the criteria is configured to cause the user equipment to perform one or more actions when the criteria is met.

The criteria may comprise at least one of expiry of a timer, a timer reaching a threshold value, a time the user equipment has been in the inactive state and a data transfer pattern.

The apparatus may be caused to transmit an indication of the criteria with the indication to operate in an inactive state or in system information.

The apparatus may be caused to receive, at the network from the user equipment, information relating to the inactive state.

The information relating to the inactive state may comprise at least one of an indication of whether data transmission is expected, a time for which the user equipment has been in the inactive state, a time for which the user equipment has been in the inactive state without data transmission, an indication of whether the user equipment has been in the inactive state for a given amount of time, an indication that the timer has expired and a data transfer pattern.

The data transmission may be associated with at least one data radio bearer, at least one logical channel or at least one protocol data unit session.

The data transmission may be downlink or uplink user data.

The criteria may comprise a message from the network.

The message may comprise a paging message or a connection establishment message.

In a seventh aspect, there is provided a computer readable medium comprising program instructions for causing an apparatus to perform at least the following: receiving an indication, at a user equipment from a network, to operate in an inactive state; receiving a criteria related to the inactive state; and in response to the criteria being met, performing one or more actions.

The criteria may comprise at least one of expiry of a timer, a timer reaching a threshold value, a time the user equipment has been in the inactive state and a data transfer pattern.

The apparatus may be caused to perform receiving an indication of the criteria with the indication to operate in an inactive state or in system information.

The criteria may be preconfigured.

The apparatus may be caused to perform: determining information relating to the inactive state. The apparatus may be caused to perform providing the information to the network.

The information relating to the inactive state may comprise at least one of an indication of whether data transmission is expected, a time for which the user equipment has been in the inactive state, a time for which the user equipment has been in the inactive state without data transmission, an indication of whether the user equipment has been in the inactive state for a given amount of time, an indication that the timer has expired and a data transfer pattern.

The data transmission may be associated with at least one data radio bearer, at least one logical channel or at least one protocol data unit session.

The data transmission may be downlink or uplink user data.

The apparatus being caused to perform one or more actions may comprise the apparatus being caused to perform operating in an idle state.

The criteria may comprise a message from the network.

The message may comprise a paging message or a connection establishment message.

In an eighth aspect, there is provided a computer readable medium comprising program instructions for causing an apparatus to perform at least the following: transmitting an indication, from a network to a user equipment, to operate in an inactive state; and transmitting a criteria related to the inactive state, wherein the criteria is configured to cause the user equipment to perform one or more actions when the criteria is met.

The criteria may comprise at least one of expiry of a timer, a timer reaching a threshold value, a time the user equipment has been in the inactive state and a data transfer pattern.

The apparatus may be caused to transmit an indication of the criteria with the indication to operate in an inactive state or in system information.

The apparatus may be caused to receive, at the network from the user equipment, information relating to the inactive state.

The information relating to the inactive state may comprise at least one of an indication of whether data transmission is expected, a time for which the user equipment has been in the inactive state, a time for which the user equipment has been in the inactive state without data transmission, an indication of whether the user equipment has been in the inactive state for a given amount of time, an indication that the timer has expired and a data transfer pattern.

The data transmission may be associated with at least one data radio bearer, at least one logical channel or at least one protocol data unit session.

The data transmission may be downlink or uplink user data.

The criteria may comprise a message from the network.

The message may comprise a paging message or a connection establishment message.

In a ninth aspect there is provided a non-transitory computer readable medium comprising program instructions for causing an apparatus to perform at least the method according to the third or fourth aspect.

In the above, many different embodiments have been described. It should be appreciated that further embodiments may be provided by the combination of any two or more of the embodiments described above.

### DESCRIPTION OF FIGURES

Embodiments will now be described, by way of example only, with reference to the accompanying Figures in which:

FIG. 1 shows a schematic diagram of an example communication system comprising a base station and a plurality of communication devices;

FIG. 2 shows a schematic diagram of an example mobile communication device;

FIG. 3 shows a schematic diagram of an example control apparatus;

FIG. 4 shows a flowchart of a method according to an example embodiment;

FIG. 5 shows a signalling flow according to an example embodiment.

### DETAILED DESCRIPTION

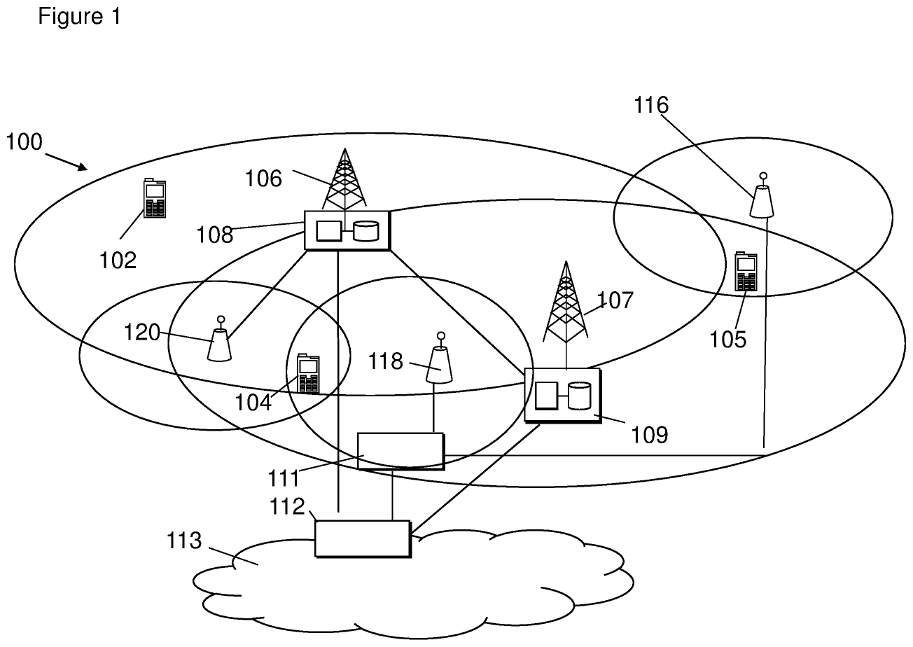

Before explaining in detail the examples, certain general principles of a wireless communication system and mobile communication devices are briefly explained with reference to FIGS. 1 to 3 to assist in understanding the technology underlying the described examples.

In a wireless communication system 100, such as that shown in FIG. 1, communication devices (e.g., user equipment (UE)) 102, 104, 105 are provided wireless access via at least one base station or similar wireless transmitting and/or receiving node or point. Base stations are typically controlled by at least one appropriate controller apparatus, so as to enable operation thereof and management of mobile communication devices in communication with the base stations. The controller apparatus may be located in a Radio Access Network (RAN) (e.g. wireless communication system 100) or in a core network (CN) (not shown) and may be implemented as one central apparatus or its functionality may be distributed over several apparatuses. The controller apparatus may be part of the base station and/or provided by a separate entity such as a radio network controller. In FIG. 1 control apparatus 108 and 109 are shown to control the respective macro level base stations 106 and 107. The control apparatus of a base station can be interconnected with other control entities. The control apparatus is typically provided with memory capacity and at least one data processor. The control apparatus and functions may be distributed between a plurality of control units. In some systems, the control apparatus may additionally or alternatively be provided in a radio network controller.

In FIG. 1 base stations 106 and 107 are shown as connected to a wider communications network 113 via gateway 112. A further gateway function may be provided to connect to another network.

The smaller base stations 116, 118 and 120 may also be connected to the network 113, for example by a separate gateway function and/or via the controllers of the macro level stations. The base stations 116, 118 and 120 may be pico or femto level base stations or the like. In the example, base stations 116 and 118 are connected via a gateway 111 whilst base station 120 connects via the controller apparatus 108. In some embodiments, the smaller base stations may not be provided. Smaller base stations 116, 118 and 120 may be part of a second network, for example a wireless network, a wireless local area network (WLAN) and may be access points (AP), WLAN Access Points (APs).

The communication devices 102, 104, 105 may access the communication system based on various access techniques, such as code division multiple access (CDMA), or wideband CDMA (WCDMA). Other non-limiting examples comprise time division multiple access (TDMA), frequency division multiple access (FDMA) and various schemes thereof such as the interleaved frequency division multiple access (I FDMA), single carrier frequency division multiple access (SC-FDMA) and orthogonal frequency division multiple access (OFDMA), space division multiple access (SDMA) and so on.

An example of wireless communication systems are architectures standardized by the 3rd Generation Partnership Project (3GPP). A latest 3GPP based development is often referred to as the long term evolution (LTE) of the Universal Mobile Telecommunications System (UMTS) radio-access technology. The various development stages of the 3GPP specifications are referred to as releases. More recent developments of the LTE are often referred to as LTE Advanced (LTE-A). The LTE (LTE-A) employs a radio mobile architecture known as the Evolved Universal Terrestrial Radio Access Network (E-UTRAN) and a core network known as the Evolved Packet Core (EPC). Base stations of such systems are known as evolved or enhanced Node Bs (eNBs) and provide E-UTRAN features such as user plane Packet Data Convergence/Radio Link Control/Medium Access Control/Physical layer protocol (PDCP/RLC/MAC/PHY) and control plane Radio Resource Control (RRC) protocol terminations towards the communication devices. Other examples of radio access system comprise those provided by base stations of systems that are based on technologies such as wireless local area network (WLAN). A base station can provide coverage for an entire cell or similar radio service area. Core network elements include Mobility Management Entity (MME), Serving Gateway (S-GW) and Packet Gateway (P-GW).

An example of a suitable communications system is the 5G or NR concept. Network architecture in NR may be similar to that of LTE-advanced. Base stations of NR systems may be known as next generation Node Bs (gNBs). Changes to the network architecture may depend on the need to support various radio technologies and finer QoS support, and some on-demand requirements for e.g. Quality of Service (QoS) levels to support Quality of Experience (QoE) for a user. Also network aware services and applications, and service and application aware networks may bring changes to the architecture. Those are related to Information Centric Network (ICN) and User-Centric Content Delivery Network (UC-CDN) approaches. NR may use multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates.

Future networks may utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations to be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

An example 5G core network (CN) comprises functional entities. The CN is connected to a UE via the radio access network (RAN). A User Plane Function (UPF) whose role is called PDU Session Anchor (PSA) may be responsible for forwarding frames back and forth between the data network (DN) and the tunnels established over the 5G towards the UE(s) exchanging traffic with the DN. A frame may include one or more packet data units (PDUs) related to the UE and provides user data back and forth to the UE.

The UPF is controlled by a Session Management Function (SMF) that receives policies from a Policy Control Function (PCF). The CN may also include an Access & Mobility Function (AMF).

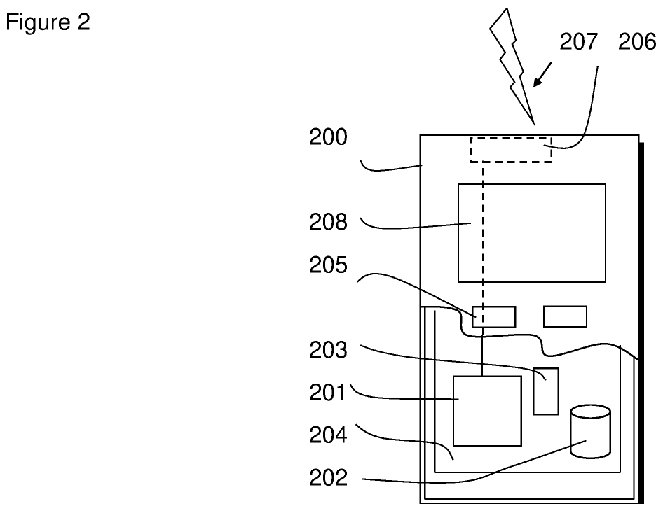

A possible mobile communication device will now be described in more detail with reference to FIG. 2 showing a schematic, partially sectioned view of a communication device 200. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, voice over IP (VoIP) phones, portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), smart devices, wireless customer-premises equipment (CPE), or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

A mobile device is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto.

The mobile device 200 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

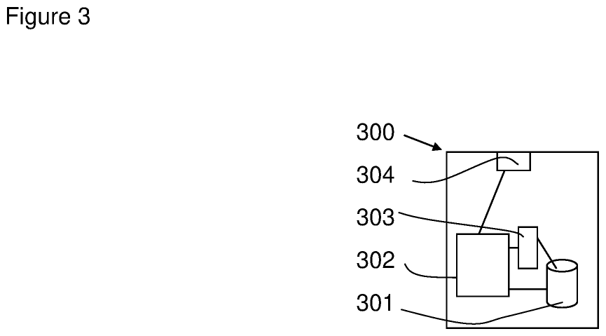

FIG. 3 shows an example of a control apparatus 300 for a communication system, for example to be coupled to and/or for controlling a station of an access system, such as a RAN node, e.g. a base station, eNB or gNB, a relay node or a core network node such as an MME or S-GW or P-GW, or a core network function such as AMF/SMF, or a server or host. The method may be implemented in a single control apparatus or across more than one control apparatus. The control apparatus may be integrated with or external to a node or module of a core network or RAN. In some embodiments, base stations comprise a separate control apparatus unit or module. In other embodiments, the control apparatus can be another network element such as a radio network controller or a spectrum controller. In some embodiments, each base station may have such a control apparatus as well as a control apparatus being provided in a radio network controller. The control apparatus 300 can be arranged to provide control on communications in the service area of the system. The control apparatus 300 comprises at least one memory 301, at least one data processing unit 302, 303 and an input/output interface 304. Via the interface the control apparatus can be coupled to a receiver and a transmitter of the base station. The receiver and/or the transmitter may be implemented as a radio front end or a remote radio head.

In NR, there is a UE RRC INACTIVE state. The UE RRC INACTIVE state may improve the latency when transitioning to RRC CONNECTED and/or support small data transmissions without the UE transitioning to RRC CONNECTED. When a UE is in the RRC INACTIVE state, conversely to the RRC IDLE state, the network has to store at least the UE AS context, keep CN/RAN connection and base UE mobility on cell reselections. The access stratum (AS) context includes at least one or more parameters relevant to AS security procedures between UE and network, one or more parameters relevant to establish and operate a signalling bearer between UE and network, one or more parameters to identify the UE in the network, one or more parameters relevant to location and/or movement of the UE within the network, one or more parameters on operations to transmit and/or receive user data and/or signalling data, wherein the data transmission and/or reception is ongoing/pending or has been completed.

For the network to support RRC INACTIVE, it may require a significant increase in memory usage at the network. Currently, networks may not be able to support the number of devices potentially available to transition to RRC INACTIVE. Upon reaching the limit to the amount of INACTIVE UEs, the network must release some UEs, or directly transition UEs in RRC CONNECTED into RRC IDLE. It may also be challenging for the network to know how long an individual UE has been in INACTIVE and/or CONNECTED state without any need for the connection, i.e., without any DL/UL user data transmissions. The network includes one or more nodes as shown e.g., in FIGS. 1 and 3 which represent the memory of the network. When a node of the network reaches the limit to the amount of INACTIVE UEs, the node may also release some UEs as described for the network above. The behaviour described for the network may also apply to a node of the network.

It may be of benefit for the UE to stay in the RRC ACTIVE state. The power consumption is lower, in comparison with the RRC INACTIVE state while the connectivity potential is high. For the network to decide whether a UE should go into RRC INACTIVE state, or RRC IDLE state it would be of benefit to know whether the UE expects any data to arrive soon.

Currently, an option for the UE to transmit the transition preference in UE assistance information from RRC CONNECTED to RRC INACTIVE or RRC IDLE has been discussed. This option may only fix the problem in some scenarios. If all, or many, UEs within a cell prefer RRC INACTIVE, it would be of benefit to control this.

Periodic RNA (RAN-level notification area) updates is an alternative option. In this option, a network may release the RRC INACTIVE UE to RRC IDLE if the UE triggers a periodic RNA update. However, as above, there still is a probability for the network to have too many UEs in RRC INACTIVE.

This method seeks to ease the networks ability to select which UEs should be in RRC INACTIVE. The following may enable a network to make a controlled decision on which UEs should transition to RRC IDLE from RRC INACTIVE, or potentially from RRC CONNECTED, based on information from the UEs of the time spent in RRC INACTIVE.

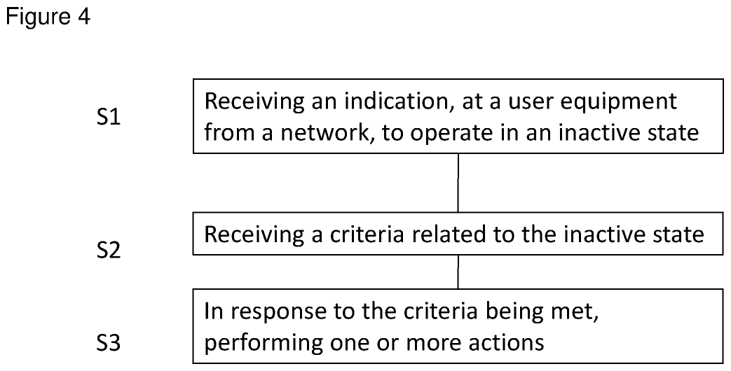

FIG. 4 shows a flowchart of a method according to an example embodiment.

In a first step, S1, the method comprises receiving an indication, at a user equipment from a network, to operate in an inactive state.

In a second step, S2, the method comprises receiving a criteria related to the inactive state.

In a third step, S3, the method comprises, in response to the criteria being met, performing one or more actions.

An indication of the criteria may be received with the indication to operate in the inactive state or in system information (SI).

The criteria may comprise at least one of expiry of a timer, a timer reaching a threshold value, a time the user equipment has been in the inactive state, a time the user equipment has been in the inactive state without data transmission and a data transfer pattern.

An indication of the timer value may be provided to the network in the same message as the indication to operate in the inactive state (i.e. to change the UE state). Alternatively, or in addition, the timer value may be configured separately, e.g., the timer value may be cell specific and indicated in the system information. A data transfer pattern may include e.g., data rate, amount of data and/or next transmission occasion.

Alternatively, or in addition, the criteria may comprise a message from the network. The message may be a paging message or a connection establishment message (e.g., RRC message such as RRC Resume message).

The method may comprise determining information relating to the inactive state to the network. The one or more action may comprise providing the information to the network. The one or more action may comprise operating in an idle state.

The inactive state may be a RRC INACTIVE state. The indication to operate in the inactive state may be a RRC release message.

The method may allow the network to keep track of the UEs time spent in RRC INACTIVE without any data transmission, as well as other behaviour. Such information may not be able to be obtained or determined from the network perspective, but may be obtained in several different ways, which are described here.

In an example embodiment, when a UE state is changed to RRC INACTIVE, the UE starts a timer. The timer value is based on the indication of the timer value.

The UE may determine information relating to the inactive state by tracking behaviour when it is in the RRC INACTIVE state. The behaviour may include, for example, how long the UE has been inactive or in RRC INACTIVE state without data transmission. Information relating to the inactive state may comprise at least one of an indication of whether data transmission is expected, a time for which the user equipment has been in the inactive state, a time for which the user equipment has been in the inactive state without data transmission, an indication of whether the user equipment has been in the inactive state for a given amount of time, a data transfer pattern, a request to stay in the inactive state, statistics on previous inactive state times and an indication that a timer has expired.

The data transmission may be downlink or uplink user data, i.e., not control data such as RRC or NAS signalling.

A UE may indicate whether a data transmission is expected, e.g., based on applications or services running in the UE. The UE may additionally indicate to the network when a data transmission is expected, a data transfer pattern, the amount of data expected and/or indicate a data rate of expected data.

The data transmission may be associated with at least one data radio bearer, at least one logical channel or at least one protocol data unit session. User data transmissions may be e.g. transmissions over a data radio bearer (DRB) or using certain logical channel or PDU session etc. A network may configure if data from only a subset of, e.g., the configured PDU sessions and/or DRBs is considered.

In an example embodiment, the criteria comprises a message from the network. The message may be a paging message.

For example, an “INACTIVE polling” information element may be added to the paging message or, alternatively, in a system information message, where the information element indicates to one or more UEs to provide the determined information related to the INACTIVE state to the network. An information element “inactive state information polling” may be added to a paging message or a system information message, where the information element indicates to one or more UEs to provide the determined information related to the inactive state to the network.

Polling of inactive state information may be enabled in the network or by a node of the network when the network or node of the network is approaching the limit of inactive UEs (as opposed to scenarios where the network is far away from the limit) in order to limit the number of messages to be transferred.

The method may comprise providing the information relating to the inactive state to the network when the criteria is met.

The criteria may comprise a message which includes the polling information element or there may be additional criteria (which may be referred to as polling criteria), such as expiry of the timer. The UEs that fulfill the polling criteria will answer the paging with INACTIVE status.

The polling criteria may be expiry of a timer or if a timer has reached a threshold value. Polling criteria may include at least one of the UE's current time in RRC INACTIVE without data transmission, expiry of the timer, configured criteria met (for example time threshold) and the UE's expected data transfer pattern. The data transfer pattern may include e.g., data rate, amount of data and/or next transmission occasion. When configuring the UE to transition to RRC INACTIVE, the network may configure the polling criteria at which the UE should reply to the network by providing an indication of information relating to the inactive state.

The UE may indicate the information relating to the inactive state in MSG 1, 3, 5 or any other message (e.g. as an Information Element in a message of a communication protocol e.g., PHY, MAC, RRC). For example, information may be added in the MSG3 that the UE is responding to “polling inactive state information”. This may be, e.g., a dedicated establishment cause value. Alternatively, such information may be added in the MSGS (RRCResumeComplete). This option may require more signaling overhead but carry more information.

In an alternative example embodiment, the network may query the UE in the connection establishment phase or during the RRC connection. That is, the message may be a connection establishment message. The UE may be requested to provide information relating to the inactive state in connection establishment phase i.e. with MSG1, MSG3 or MSGS.

In an alternative example embodiment, receiving criteria may comprise the UE being configured with criteria to trigger providing INACTIVE information to the network. The criteria may be, e.g., at least one of expiry of the timer, if the timer has reached a threshold value and time threshold in the INACTIVE state without data transmission. When criteria is fulfilled the UE provides the INACTIVE behaviour information to the network.

When a timer expires, UE may autonomously enter RRC IDLE state.

Timer expiry may be informed to the network in the next connection request or connection resume procedure, e.g., due to periodic RNA update timer expiry.

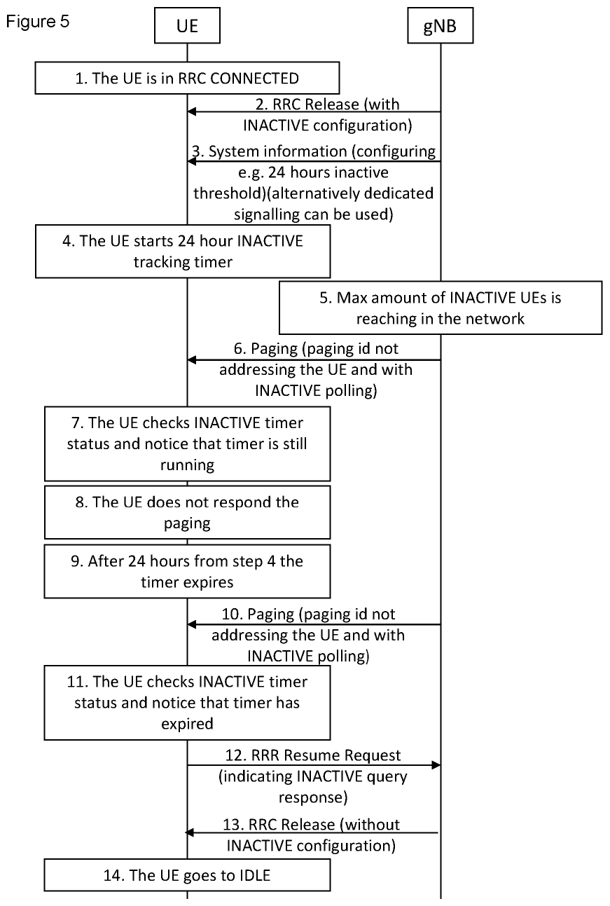

FIG. 5 shows a signalling flow for an example embodiment of the paging-based procedure. In this example, the base criteria at which the UE should provide information to the network relating to the UE RRC INACTIVE state behaviour comprises expiry of the timer. In this example embodiment, the inactive state is considered RRC INACTIVE.

In this example method of implementation, a UE is in RRC CONNECTED state in step 1 and receives an RRC Release message (i.e., an indication to operate in an inactive state) from a gNB with an INACTIVE configuration in step 2.

In step 3, the gNB sends SI with an inactive time threshold (e.g., a 24 hour inactive threshold) at which the UE should report the tracked behaviour. Alternatively, the inactive time threshold may be indicated in the RRC release message or in a dedicated signaling message. In this example embodiment means for receiving the criteria comprises means for receiving an indication of a value of a timer.

In step 4, the UE starts a timer with a value, e.g., the 24 hour INACTIVE tracking timer.

While the network is not close to the limit of UEs in RRC INACTIVE, then the paging will progress as legacy behavior.

This step may limit the number of unnecessary replies from the UEs to the network.

However, if, as shown in step 5, the network detects that it is approaching the limit of UEs in RRC INACTIVE, then the network indicates through paging messages a request for UE behavior information, i.e., information relating to the inactive state, in step 6 (and also in step 10) e.g., shown as INACTIVE polling. In this example embodiment, the criteria also comprises a paging message.

In step 7 and step 11, the UE checks the INACTIVE timer status. In step 7, the UE determines that the timer is still running. The UE does not respond to the paging in step 8. That is, if the paged UE's INACTIVE timer has not expired, the criteria is not met and the paged UE does not respond with any INACTIVE polling messages. In step 9, after 24 hours from step 4, the timer expires.

If the paged UEs INACTIVE timer has expired (as shown in step 9), then the criteria is met when the UE checks the INACTIVE timer in step 11 and the paged UE responds in step 12 by providing information relating to the inactive state, in this example the INACTIVE statistics (such as UE time in INACTIVE, a UE request to stay in INACTIVE because it assumes uplink data soon, statistics on previous INACTIVE state times) so as to help the network determine the priority of the UE being in the IDLE state.

In step 13, the gNB sends a RRC release without INACTIVE configuration and in step 14, the UE goes to IDLE.

An apparatus may comprise means for receiving an indication, at a user equipment from a network, to operate in an inactive state, receiving a criteria related to the inactive state, and in response to the criteria being met, performing one or more actions.

Alternatively, or in addition, an apparatus may comprise means for transmitting an indication, from a network to a user equipment, to operate in an inactive state, and transmitting a criteria related to the inactive state, wherein the criteria is configured to cause the user equipment to perform one or more actions when the criteria is met.

An apparatus may comprise at least one processor and at least one memory including a computer program code, the at least one memory and computer program code configured to, with the at least one processor, cause the apparatus at least to: receive an indication, at a user equipment from a network, to operate in an inactive state; receive a criteria related to the inactive state; and in response to the criteria being met, perform one or more actions.

Alternatively, or in addition, an apparatus may comprise at least one processor and at least one memory including a computer program code, the at least one memory and computer program code configured to, with the at least one processor, cause the apparatus at least to: transmit an indication, from a network to a user equipment, to operate in an inactive state; and transmit a criteria related to the inactive state, wherein the criteria is configured to cause the user equipment to perform one or more actions when the criteria is met.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst some embodiments have been described in relation to 5G networks, similar principles can be applied in relation to other networks and communication systems. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

In general, the various embodiments may be implemented in hardware or special purpose circuitry, software, logic or any combination thereof. Some aspects of the disclosure may be implemented in hardware, while other aspects may be implemented in firmware or software which may be executed by a controller, microprocessor or other computing device, although the disclosure is not limited thereto. While various aspects of the disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used in this application, the term “circuitry” may refer to one or more or all of the following:

(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The embodiments of this disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The scope of protection sought for various embodiments of the disclosure is set out by the independent claims. The embodiments and features, if any, described in this specification that do not fall under the scope of the independent claims are to be interpreted as examples useful for understanding various embodiments of the disclosure.

The foregoing description has provided by way of non-limiting examples a full and informative description of the exemplary embodiment of this disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of this invention as defined in the appended claims. Indeed, there is a further embodiment comprising a combination of one or more embodiments with any of the other embodiments previously discussed.

1. (canceled)

2. An apparatus according to claim 23, wherein the criteria comprises at least one of: expiry of a timer, a timer reaching a threshold value, a time the user equipment has been in the inactive state, or a data transfer pattern.

3. An apparatus according to claim 23, where the at least one memory and the computer program code are configured to, with the at least one processor, cause the apparatus at least to perform receiving an indication of the criteria with the indication to operate in an inactive state or in system information.

4. An apparatus according to claim 23 wherein the criteria is preconfigured.

5. An apparatus according to claim 23, where the at least one memory and the computer program code are configured to, with the at least one processor, cause the apparatus at least to perform:
determining information relating to the inactive state; and
providing the information to the network.

6. An apparatus according to claim 5, wherein information relating to the inactive state comprises at least one of: an indication of whether data transmission is expected, a time for which the user equipment has been in the inactive state, a time for which the user equipment has been in the inactive state without data transmission, an indication of whether the user equipment has been in the inactive state for a given amount of time, an indication that the timer has expired, or a data transfer pattern.

7. An apparatus according to claim 6, wherein the data transmission is associated with at least one data radio bearer, at least one logical channel or at least one protocol data unit session.

8. An apparatus according to claim 6, wherein the data transmission is downlink or uplink user data.

9. An apparatus according to claim 23, wherein the at least one memory and the computer program code are configured to, with the at least one processor, cause the apparatus at least to perform operating in an idle state.

10. An apparatus according to claim 23, wherein the criteria comprises a message from the network.

11. An apparatus according to claim 10, wherein the message comprises a paging message or a connection establishment message.

12. (canceled)

13. An apparatus according to claim 24, wherein the criteria comprises at least one of: expiry of a timer, a timer reaching a threshold value, a time the user equipment has been in the inactive state, or a data transfer pattern.

14. An apparatus according to claim 24, where the at least one memory and the computer program code are configured to, with the at least one processor, cause the apparatus at least to perform transmitting an indication of the criteria with the indication to operate in an inactive state or in system information.

15. An apparatus according to claim 24, where the at least one memory and the computer program code are configured to, with the at least one processor, cause the apparatus at least to perform:
receiving, at the network from the user equipment, information relating to the inactive state.

16. An apparatus according to claim 15, wherein the information relating to the inactive state comprises at least one of: an indication of whether data transmission is expected, a time for which the user equipment has been in the inactive state, a time for which the user equipment has been in the inactive state without data transmission, an indication of whether the user equipment has been in the inactive state for a given amount of time, an indication that the timer has expired, or a data transfer pattern.

17. An apparatus according to claim 16, wherein the data transmission is associated with at least one data radio bearer, at least one logical channel or at least one protocol data unit session.

18. An apparatus according to claim 16, wherein the data transmission is downlink or uplink user data.

19. An apparatus according to claim 24, wherein the criteria comprises a message from the network.

20. An apparatus according to claim 19, wherein the message comprises a paging message or a connection establishment message.

21. A method comprising:
receiving an indication, at a user equipment from a network, to operate in an inactive state;
receiving a criteria related to the inactive state; and
in response to the criteria being met, performing one or more actions.

22. A method comprising:
transmitting an indication, from a network to a user equipment, to operate in an inactive state; and
transmitting a criteria related to the inactive state, wherein the criteria is configured to cause the user equipment to perform one or more actions when the criteria is met.

23. An apparatus comprising:
at least one processor; and
at least one non-transitory memory including a computer program code,
the at least one memory and computer program code configured to, with the at least one processor, cause the apparatus at least to:
receive an indication, at a user equipment from a network, to operate in an inactive state;
receive a criteria related to the inactive state; and
in response to the criteria being met, perform one or more actions.

24. An apparatus comprising:
at least one processor; and
at least one non-transitory memory including a computer program code,
the at least one memory and computer program code configured to, with the at least one processor, cause the apparatus at least to:
transmit an indication, from a network to a user equipment, to operate in an inactive state; and
transmit a criteria related to the inactive state, wherein the criteria is configured to cause the user equipment to perform one or more actions when the criteria is met.

25. A non-transitory computer readable medium comprising program instructions for causing an apparatus to perform at least the the method as claimed in claim 21.

26. A non-transitory computer readable medium comprising program instructions for causing an apparatus to perform the method as claimed in claim 22.
